(19) United States
(12) Patent Application Publication
(10) Pub. No.: US 2026/0065074 A1
(43) Pub. Date: Mar. 5, 2026

(54) COMPUTER-IMPLEMENTED METHOD, COMPUTER PROGRAM PRODUCT AND COMPUTER SYSTEM FOR SELECTION OF FOUNDATION MODELS

(71) Applicant: Accenture Global Solutions Limited, Dublin (IE)

(72) Inventors: Sankar Narayan DAS, Barrackpore (IN); Kuntal Dey, Birbhum (IN); Kaushik Amar Das, Guwahati (IN); Samdyuti Suri, Faridabad (IN); Vibhu Saujanya Sharma, Bangalore (IN); Vikrant Kaulgud, Pune (IN); Teresa Sheausan Tung, Los Angeles, CA (US)

(21) Appl. No.: 18/817,135

(22) Filed: Aug. 27, 2024

(51) Int. Cl. G06N 3/0985

(52) U.S. Cl. CPC G06N 3/0985

(57) ABSTRACT

Methods, systems, and computer-readable storage media for selecting foundation models. For selecting the foundation models, tasks and contextual parameters are obtained. The contextual parameters include functional requirement values and user preferences. The functional requirement values describe operating characteristics of a foundation model of a plurality of foundation models. Based on the functional requirement values and the user preference values, utility values of the foundation model are estimated. Based on the estimated utility values, a set of foundation models from the plurality of foundation models is selected. The functional requirement values and the user preference values constrain the selection of the foundation models. The selected set of foundation models are outputted for performing the tasks.

### FIELD OF THE INVENTION

Various embodiments described herein relate generally to computer-implemented method, computer system, and computer program product for selection of foundation models.

### BACKGROUND

Enterprises continuously seek to improve and gain efficiencies in their operations. To this end, enterprises employ software systems to support execution of tasks/operations. Enterprises integrate the software systems in the domain of an intelligent enterprise, which employs artificial intelligence (AI) that can include, for example, machine learning (ML) models. For example, AI can be used for data analytics and/or automating tasks in support of enterprise operations.

In the field of AI, Generative AI (GAI) has recently seen an explosion in popularity. The increasing power and popularity of GAI has seen enterprises seeking avenues to leverage GAI in improving enterprise operations. GAI includes foundation models that generate a variety of content including, but not limited to, text, images, audio, and video based on training data. Examples of the foundation models include Large Language Models (LLMs), which are a form of GAI that can be used to generate text for a variety of use cases.

### SUMMARY

Implementations of the present disclosure are generally directed to optimizing selection of foundation models for performing one or more tasks. The foundation models are selected based on contextual parameters indicating functional requirement values and user preferences associated with the one or more tasks. Therefore, performance and efficiency of the foundation models are improved while reducing sustainability issues.

In general, innovative aspects of the subject matter described in this specification provide a method for selecting foundation models. The method includes obtaining a plurality of tasks and a plurality of contextual parameters. The plurality of contextual parameters includes a plurality of functional requirement values and user preference values. The functional requirement values describe operating characteristics of a foundation model of a plurality of foundation models. After obtaining the plurality of contextual parameters, the method includes estimating utility values of the foundation model. The estimated utility values are based on the plurality of functional requirement values and user preference values. Based on the estimated utility values, the method includes selecting a set of foundation models from the plurality of foundation models. The plurality of functional requirement values and user preference values constrain the selection of the set of foundation models. Once the set of foundation models is selected, the method includes outputting the set of foundation models for performing the plurality of tasks.

The present disclosure further describes a system for implementing the method provided herein. The present disclosure also describes computer-readable storage media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DRAWINGS

Various embodiments in accordance with the present disclosure will be described with reference to the drawings, in which:

FIG. 1 depicts an example environment that may be used to execute implementations of the present disclosure.

FIG. 2 depicts an example block diagram of a model selector including components for generating a foundation model pipeline for tasks in accordance with implementations of the present disclosure.

FIG. 3 depicts an example process flow of generating the foundation model pipeline for the tasks in accordance with implementations of the present disclosure.

FIGS. 4A and 4B depict example utility functions mapped to functional requirement values associated with exemplary tasks in accordance with implementations of the present disclosure.

FIG. 5 is a flow diagram that presents an example method for selecting the set of foundation models for the tasks in accordance with implementations of the present disclosure.

FIG. 6 illustrates a computer system that may be used to implement the model management system.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” (e.g., “for example”, “an example of”, by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

With the advent of Generative Artificial Intelligence (GAI) systems, enterprises are adopting the GAI systems to support execution of various tasks/processes. For example, a GAI system may support communications and interactions, and processes in software systems to support decision-making within the enterprises. Multiple applications within a corporate network environment may use and interact with foundation models/Large Language Models (LLMs) of the GAI systems to provide input and/or data for the execution of a wide variety of tasks, such as, human computer interactions (i.e., question and answering), automating process execution, process planning, generating step-by-step procedures for the process execution, performing data analysis, and/or the like. Therefore, the foundation models have capability of Natural Language Processing (NLP) related tasks and processing unstructured data. Due to the capability of processing the unstructured data, the foundation models can be implemented in various domains and applications such as, software engineering, computational biology, medicine, marketing, and/or the like.

Use of the multiple foundation models is suitable within an enterprise ecosystem to perform multiple tasks. However, use of the foundation models in applications being supported by the enterprises is a non-trivial task, particularly in view of a diverse range of foundation models being available for consumption. More specifically, enterprises can require access to the multiple foundation models to meet needs of disparate contexts (application tasks). Different foundation models have different strengths and weaknesses, which varies between contexts. This makes it difficult to optimize the use of foundation models, as optimization depends on a specific context. Consequently, for an application interacting with the multiple foundation models (i.e., multi-model GAI paradigm) technical controls are needed. Further, enterprises require flexibility in applications without a significant coupling to the specific foundation models. For example, an ecosystem of an enterprise may evolve over time and, as such, contexts change over time. Additionally, there are multiple factors and considerations for determining an appropriate foundation model for a given context/task. This requires significant experimentation by each application and, currently, no common standards exist. As such, significant technical resources are wasted (e.g., over multiple experiments) in an effort to integrate the foundation models into enterprise ecosystems. Further, sustainable operationalization of the foundation models at enterprise scale requires standardized governance, access, cost, service, and usage management to be in place.

In view of this, implementations of the present disclosure optimize performance of the multi-model GAI paradigm by generating a foundation model pipeline for one or more tasks. The foundation model pipeline includes a composition of a set of foundation models selected for the one or more tasks. The set of foundation models are selected by evaluating performance of each of the foundation models based on contextual parameters. The selected set of foundation models provides enhanced utility for the given contextual parameters. Therefore, efficiency and quality of the one or more tasks may be improved, while satisfying user and application specific requirements and maximizing cost, efficiency, and sustainability.

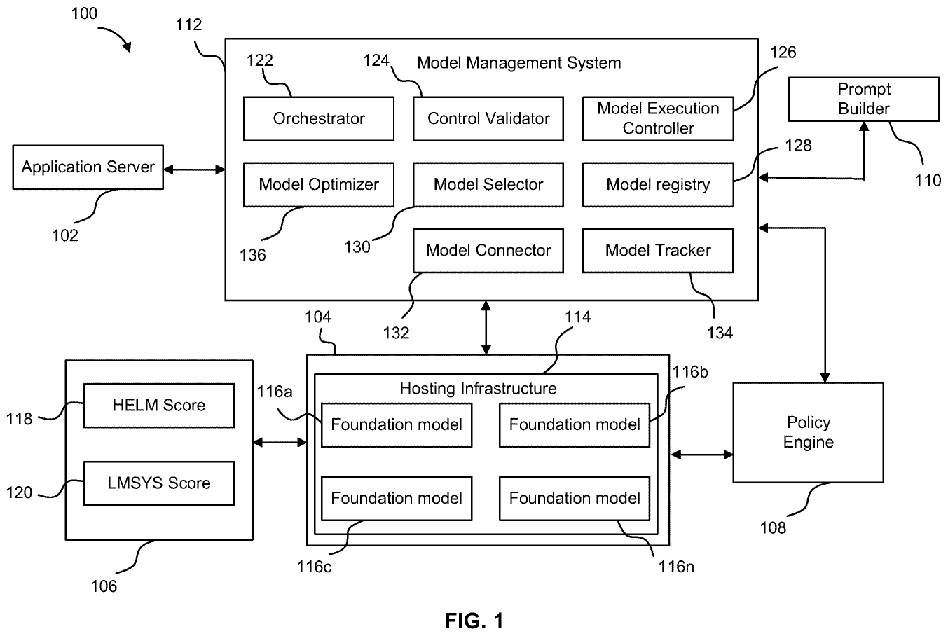

FIG. 1 depicts an example environment 100 that may be used to execute implementations of the present disclosure. In the example of FIG. 1, the example environment 100 includes one or more application servers 102, a Generative Artificial Intelligence (GAI) system 104, a model benchmark source 106, a policy engine 108, a prompt builder 110, and a model management system 112.

Each of the application servers 102 executes one or more applications that consume the GAI system 104 being implemented by enterprise systems. In an example, an application may include a chatbot that provides responses generated by the GAI system 104 responsive to inputs/requests provided by users to the chatbot. The user inputs/requests may indicate a domain and/or one or more tasks to be performed using the GAI system 104. Examples of the tasks may include text generation, text translation, question answering, code generation, process planning, process execution, data analysis, reasoning, and/or the like. The response(s) generated responsive to the user input may indicate results of the tasks being performed using the GAI system 104. In another example, the application may include any application that enables interactions with the GAI system 104 through the model management system 112 with different modalities. Examples of the modalities may include text, audio, image, video, and/or the like.

The GAI system 104 may be implemented by the enterprise systems for performing the tasks. The GAI system 104 includes a hosting infrastructure 114 to host one or more foundation models 116a-116n. It should be noted that the GAI system 104 may also include other components such as knowledge base, rules engine, and/or the like (not shown). The knowledge base includes domain knowledge associated with processes executed by the model management system 112.

The hosting infrastructure 114 represents technical infrastructure(s), where the foundation models 116a-116n are hosted. Examples of the hosting infrastructure 114 may include cloud computing platforms or the like. In some examples, the hosting infrastructure 114 may host the foundation models 116a-116n in different types of paradigms, which include, without limitation, model-as-a service (MaaS) models, specialized MaaS (SMaaS) models, self-deployed models, and/or the like.

In some examples, the foundation models 116a-116n may be provided by one or more third parties or the enterprise systems hosting the applications on the application server 102. A foundation model 116a-116n receives the requests/queries and provides the responses to the model management system 112 of the present disclosure. For example, the requests/queries may be received from the model management system 112 as prompts through an Application Programming Interface (API).

The foundation model 116a-116n may be described as a general-purpose GAI model like large deep learning neural network. The large deep learning neural network may be trained using a broad range of generalized, unlabeled training data and that may perform the tasks. In some examples, the applications may be built on top of the foundation models 116a-116n and the foundation models 116a-116n may be used to perform a range of functionality for the application.

The foundation models 116a-116n may include, for example, Large Language Models (LLMs), which are a form of GAI that may be used to generate text for a variety of use cases. In some examples, the LLMs may be integrated in digital assistants (for example, chatbots), replacing traditional rule-based systems to provide textual responses to a user input. A LLM may be described as an advanced type of language model that is trained using deep learning techniques on massive amounts of text data. The text data is general and not specific to any particular domain. A LLM may described as an advanced type of language model that is trained using deep learning techniques on massive amounts of text data. The text data is general and not specific to any particular domain. The LLMs may generate human-like text and perform various Natural Language Processing (NLP) tasks (for example, translation, question-answering, and/or the like). In some examples, the LLM refers to models that use deep learning techniques and have a plurality of parameters, which may range from millions to billions. The LLMs may capture complex patterns in language and produce text that is often indistinguishable from that written by humans. The produced text may be processed through a deep learning architecture such as, recurrent neural network (RNN), a transformer model, and/or the like.

While implementations of the present disclosure are described in further detail herein with non-limiting reference to the LLMs as the example foundation models, it is contemplated that implementations of the present disclosure may be realized using any appropriate foundation models or Machine Learning (ML) models, or Artificial Intelligence (AI) models. Such models may generate the content/response based on any appropriate modality (for example, text, audio, image, video, and/or the like). In some examples, the response may correspond to one or more of the tasks being represented by the request/prompt.

In some examples, the model benchmark source 106 provides benchmark data for the foundation models 116a-116n hosted in the hosting infrastructure 114. The benchmark data may be provided for the foundation models 116a-116n with respect to domains and/or use-case scenarios (for example, the tasks to be performed). The benchmark data may be provided by a third-party service that is queried by the model management system 112. For example, a request/query received from a user may indicate a domain and/or a task and the model benchmark source 106 may return the benchmark data to the model management system 112 in responsive to the request/query.

In some examples, the benchmark data may include Holistic Evaluation of Language Model (HELM) scores 118, Large Model Systems (LMSYS) scores 120, and/or the like, of the foundation models 116a-116n. The HELM scores 118 and the LMSYS scores 120 of the foundation models 116a-116n may define functional values of the foundation models 116a-116n that are deployed using a specific hardware instance. The functional values of the foundation models 116a-116n may represent evaluation of performance of the foundation models 116a-116n with respect to execution of the tasks. Examples of the functional values of the foundation models 116a-116n may include availability, cost, latency, accuracy, size, run-time, and/or the like of the respective foundation models 116a-116n.

In some examples, the policy engine 108 provides functional requirement values and user preference values associated with the tasks. The functional requirement values and the user preference values in combination provides a context for performing the tasks.

The functional requirement values (also be referred to as task requirements, application requirements, or the like) indicate operating characteristics of the foundation models 116a-116n required to be satisfied, while performing the tasks. The functional requirement values may indicate accuracy, latency, size, run time and/or the like of the foundation models 116a-116n required for the tasks.

The user preference values indicate model execution rules for executing the foundation models 116a-116n in a production environment based on experiments, comparisons, benchmarks, and/or the like. The user preference values may indicate for example, user preferences, user-policy details, and/or the like, for executing the foundation models 116a-116n. It should be noted that the user preference values may be obtained and stored by the policy engine 108 based on consent received by the users, and/or the like for collection and use of the user preferences values. The user preference values may be stored per regulations and the prior consent. Also, the user preference values may be deleted per regulations and the prior consent, and that implementations of the present disclosure may operate only on the small slice of the user preferences values for which the consent is obtained.

In some examples, the prompt builder 110 enables building of the prompts for querying the foundation models 116a-116n. The prompts may be built using a set of prompt templates. For example, a library of prompt templates may be maintained, and each prompt template provides a pattern that is specific to the foundation model 116a-116n. In some examples, the prompt builder 110 enables the users to build and experiment with the prompts and compare the responses across the multiple foundation models 116a-116n. In such a way, the users may consider the quality of responses and quantitatively determine cost and latency to use of the respective foundation models 116a-116n.

In some examples, the model management system 112 may be implemented as an on-premises system that is operated by the enterprise or a third-party engaged in cross-platform interactions and data management. In some examples, the model management system 112 may be implemented as an off-premises system (for example, cloud or on-demand) that is operated by the enterprise or a third-party on behalf of the enterprise. In some examples, the model management system 112 may be implemented in a cloud environment. Further, the model management system 112 may be intended to represent various forms of servers including a web server, a proxy server, a network server, a server pool, and/or the like. The model management system 112 may include one or more processors (not shown) such as, but not limited to, microprocessors, microcomputers, microcontrollers, digital signal processors, central processing units, state machines, logic circuits, and/or any devices that manipulate data or signals based on operational instructions. Among other capabilities, the processor may fetch and execute computer-readable instructions in a memory operationally coupled with the model management system 112.

The model management system 112 submits the requests/inputs to and receives responses from the foundation models 116a-116n executing within the hosting infrastructure 114. The requests may be submitted to the foundation models 116a-116n through the API. For example, the requests may include the prompts for the tasks to be performed. In some examples, the prompts are sent to the foundation models 116a-116n in response to the requests received by the model management system 112 from the applications being executed by the application server(s) 102. Further, the responses received from the foundation models 116a-116n are returned to the applications.

The model management system 112 includes an orchestrator 122, a control validator 124, a model execution controller 126, model registry 128, a model selector 130, and a model connector 132.

The orchestrator 122 handles the requests to the model management system 112 (for example, from the applications executed on the application server(s) 102) for comparing, routing, and the like, by orchestrating execution of a suite of granular services and functions. The control validator 124 identifies controls that are to be applied while making the requests to the foundation models 116a-116n for enforcing governance policies.

The model execution controller 126 enables browsing of the model registry 128, sending of instructions to the model selector 130 for model comparisons, selections and composing of rules for executing the foundation models 116a-116n in the production environment. The model registry 128 manages a pre-approved foundation models 116a-116n (for example, registering the foundation models 116a-116n) available for consumption and associated architectural configurations for scaling.

The model selector 130 generates a foundation model pipeline by selecting a set of foundation models from the foundation models 116a-116n for performing the one or more tasks.

According to implementations of the present disclosure, for selecting the set of foundation models, the model selector 130 obtains a plurality of tasks and a plurality of contextual parameters. The tasks may be obtained from the application(s) being executed by the application server(s) 102.

The contextual parameters include the functional requirement values and the user preference values associated with the tasks. In some examples, the model selector 130 may obtain the functional requirement values and the user preference values from the policy engine 108.

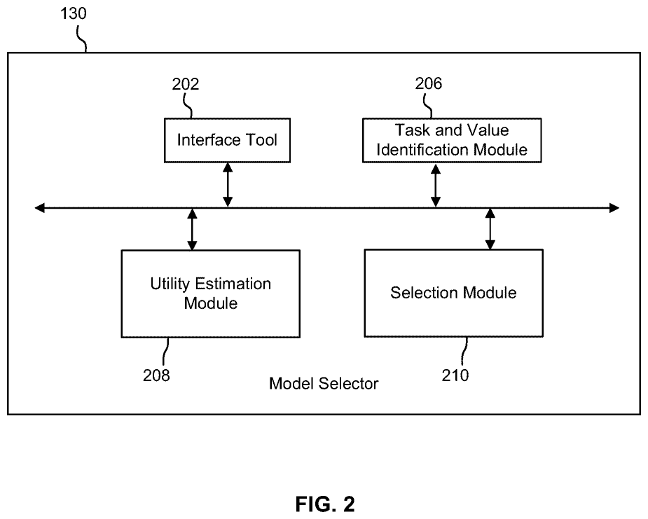

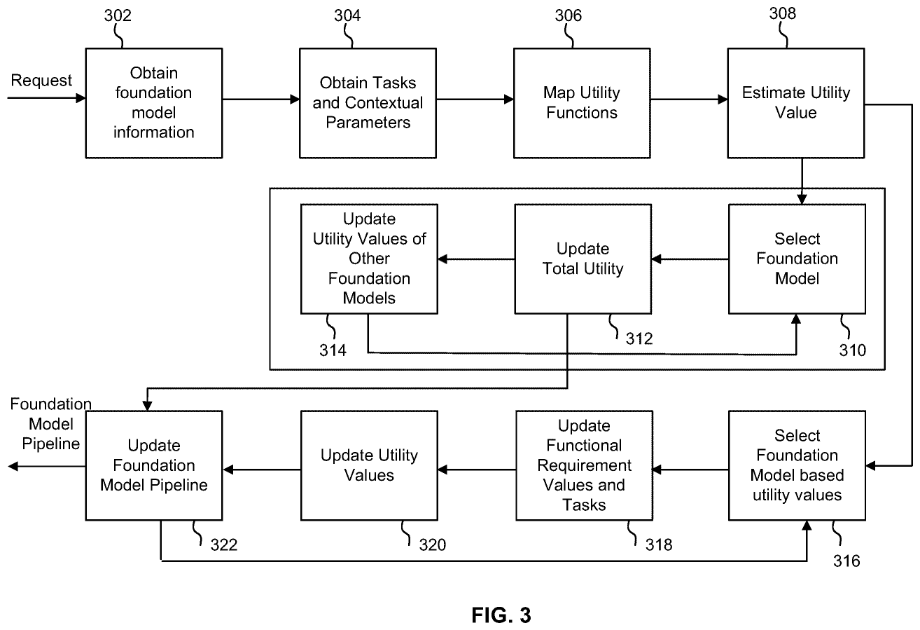

Based on the obtained contextual parameters, the model selector 130 estimates utility values of each of the foundation models 116a-116n with respect to the functional requirement values. Further, based on the utility values of each the foundation models 116a-116n, the model selector 130 selects the set of foundation models from the foundation models 116a-116n based on the utility values of each foundation model. Therefore, the functional requirement values and the user preference values constrain the selection of the set of foundation models. The model selector 130 outputs the selected set of foundation models for performing the requested tasks. The selected set of foundation models may be outputted in form of the foundation model pipeline. The foundation model pipeline includes a composition of the selected set of foundation models. The model selector 130 is described in detail in conjunction with FIGS. 2 and 3.

The model connector 132 enables communication/interactions with the set of foundation models selected by the model selector 130 for performing the tasks.

In some examples, the model management system 112 may further include a model tracker 134 and the model optimizer 136.

The model tracker 134 records data representative of use of the foundation models 116a-116n. Example data may include requests submitted to and responses received from the foundation models 116a-116n, the functional values (e.g., latency, quota, availability, cost) of the foundation models 116a-116n satisfied while performing the tasks, and the user preference values in use of the foundation models 116a-116n. The model tracker 134 may provide the recorded data to the model benchmark source 106 and the policy engine 108.

The model optimizer 136 processes one or more objectives set for the application (for example, by an application developer) to cascade through the multiple foundation models 116a-116n and identify the selected set of foundation models that meet objectives set for the application/task.

Various examples depicting selection of the set of foundation models for performing the tasks are described in detail in conjunctions with figures below.

FIG. 2 depicts an example block diagram of the model selector 130 including components for generating the foundation model pipeline for the tasks in accordance with implementations of the present disclosure. The model selector 130 identifies the tasks from the request(s) received from the application(s) being executed on the application server(s) 102 and selects the set of foundation models for the identified tasks. The selected set of foundation models are included in the foundation model pipeline.

As depicted in FIG. 2, the model selector 130 includes an interface tool 202, task and value identification module 206, a utility estimation module 208, and a selection module 210.

The interface tool 202 may represent one or more front-end components/interfaces of the application that may be executed on the application server 102 to enable receipt of the request and providing the response(s) to the request. In some examples, the request may include the prompt and may be received through various modalities including, but not limited to, a question input to a chat bot, a request provided through a Graphical User Interface (GUI), an email, and/or the like.

The task and value identification module 206 may obtain the tasks. In some examples, the tasks may include text generation, translation, question and answering, code generation, process planning, process execution, data analysis, reasoning, and/or the like. The task and value identification module 206 may obtain the tasks from the requests received from the application being executed on the application server 102. Each of the tasks may represent operations to be performed using the foundation models 116a-116n of the GAI system 104.

The task and value identification module 206 may also obtain the contextual parameters from the policy engine 108. The contextual parameters may define a context for selecting the set of foundation models from the foundation models 116a-116n for the tasks. The contextual parameters include the functional requirement values and the user preference values associated with the tasks.

The functional requirement values may indicate operating characteristics of the foundation models 116a-116n to be satisfied, while performing the tasks. Examples of the functional requirement values may include accuracy, latency, size, run time, and/or the like, of the foundation model 116a-116n required for performing the tasks. In an example, the accuracy and associated benchmarks of the foundation model 116a-116n define the overall performance of the respective foundation model 116a-116n. In another examples, the size/run time and the latency of the foundation model 116a-116n characterize cost and sustainability issues associated with the respective foundation model 116a-116n.

The user preferences values may indicate model execution rules/requirements for execution of the foundation models 116a-116n. The execution rules/requirements may be defined in terms of user preferences, user policies, and/or the like.

Therefore, the functional requirement values and the user preference values may operate as a set of constraints for selecting the set of foundation models 116a-116n. Due to which, the context defined for the selection of the foundation models 116a-116n is characterized by the set of constraints, which effects performance of the tasks (i.e., quality of task-specific responses/output) and operational performance of each of the foundation models 116a-116n. Further, each constraint limits a value of one or more parameters of each foundation model and the requested tasks.

The task and value identification module 206 may provide the obtained tasks and the contextual parameters (including the functional requirement values and the user preference values) to the utility estimation module 208.

The utility estimation module 208 estimates utility values of each of the foundation models 116a-116n based on the contextual parameters. The utility values of the foundation model 116a-116n may represent performance of the respective foundation model 116a-116n for the obtained functional requirement values of the tasks. In an example, the performance of the foundation model 116a-116n may be referred to a quality of task-specific response(s) of the respective foundation model 116a-116n for the obtained functional requirement values.

In some examples, the utility values of the foundation models may be estimated, by way of non-limiting example, using a multi-attribute utility scheme as known in the art and not further described herein. Implementations of the present disclosure may use any other suitable method/schema (including the multi-attribute utility scheme) for estimating the utility values of the foundation model 116a-116n.

For estimating the utility values in accordance with the multi-attribute utility scheme, the utility estimation module 208 may map the functional requirement values and the user preference values to different utility functions. In some examples, the utility functions may be pre-defined by the users in accordance with the user preference values. The functional requirement values and the user preference values may be mapped to different utility functions with respect to each task. Therefore, the utility functions may be identified for each task. In an example, a utility function identified for the task may correspond to a simple linear transformation function defined with respect to one of the functional requirement values of the respective task.

Once the utility functions are identified for each task, the utility estimation module 208 may estimate the utility values of each foundation model 116a-116n by evaluating the functional values of the foundation model 116a-116n using the utility functions. An example illustration of estimating the utility values of the foundation model is described in detail in conjunction with FIG. 3.

After estimating the utility values of all the foundation models 116a-116n, the utility estimation module 208 estimates a total utility of the foundation models 116a-116n. The total utility of the foundation models 116a-116n may be referred to as an overall utility of the foundation models 116a-116n, which is estimated based on the utility values of each of the foundation models 116a-116n. Specifically, the utility estimation module 208 may estimate the total utility of the foundation models 116a-116n by evaluating the utility value of the foundation model conditional on the performance/utility value of the other foundation models (i.e., conditional on the operating characteristics of the other foundation models). Therefore, the total utility of the foundation models is estimated by comparing performance of the foundation model with respect to the other foundation models. For example, among the foundation models 116a-116n, a foundation model 116a may dominate the performance of the foundation model 116b for a task A due to different operating characteristics or the foundation models 116a and 116b may complement each other for the task A. Such operating characteristics of the individual foundation models 116a-116n may be considered while estimating the total/overall utility of the foundation models 116a-116n.

In some implementations, the utility estimation module 208 may estimate the total utility of the foundation models 116a-116n using a total utility estimation technique.

For estimating the total utility of the foundation models 116a-116n using the total utility estimation technique, the utility estimation module 208 may receive information from the task and value identification module 206. The information may include the tasks ‘T’ identified to be performed, the foundation models 116a-116n (represented as ‘L’) available for the tasks, the functional requirement values/task requirements ‘TR (j)’ associated with the tasks, the user preference values including user preferences/user-specific constraint set ‘C’ and the functional requirement values/task requirements for performing each of the tasks (‘T’).

After receiving the information, the utility estimation module 208 may select a foundation model ‘L (i)’ from the foundation models ‘L’ based on the user-specific constraint set ‘C’ for a task ‘T (j)’. For each task, the utility estimation module 208 may update the utility values of the selected foundation model with respect to the functional requirement values associated with the task. For example, a utility value ‘U (T (i, j))’ of the foundation model ‘L (i)’ may represent the utility value of the foundation model ‘L (i)’ for performing the task ‘T (j)’, while satisfying the functional requirement values ‘TR (j)’ associated with the task ‘T (j)’. Based on the updated utility values of the selected foundation model ‘L (i)’, the utility estimation module 208 may generate an individual total utility of the foundation model ‘L (i)’ by summing the utility values of the foundation model ‘L (i)’ with respect to all the functional requirement values associated with the task. Thereafter, the utility estimation module 208 may update the total/overall utility ‘TU’ of the foundation models ‘L’. For example, the total utility ‘TU’ may be updated as: TU=TU+individual total utility value (selected foundation model). The utility estimation module 208 repeats the above steps to estimate the total/overall utility of the foundation models ‘L’ with respect to other foundation models and for all the other identified tasks. An example illustration of estimating the total utility of all the foundation models is described in detail in conjunction with FIG. 3.

The utility estimation module 208 provides the utility values of each foundation model and the total/overall utility of the foundation models 116a-116n to the selection module 210.

The selection module 210 may select the set of foundation models from the foundation models 116a-116n and generates the foundation model pipeline by including the selected set of foundation models for performing the tasks.

For selecting the set of foundation models, the selection module 210 may select the available foundation models ‘L_A’ from the foundation models 116a-116n (‘L’). The available foundation models ‘L_A’ may be selected based on the user preference values obtained by the task and value identification module 206. Once the available foundation models ‘L_A’ are selected, the selection module 210 may sort/order the available foundation models based on the estimated utility values of each of the available foundation models ‘L_A’. The available foundation models ‘L_A’ may be sorted in a descending order according to their estimated utility values (′U (T (i, j))′).

Upon sorting the available foundation models ‘L_A’, the selection module 210 may select a foundation model ‘L_(j)’ from the available foundation models ‘L_A’. The selected foundation model may have the highest utility values among the other available foundation models ‘L_A’. The utility value of the selected foundation model may be added to the total/overall utility ‘TU’ (initially TU=0) of foundation models ‘L’ selected for the task. Updating the ‘TU’ based on the utility value of the selected foundation model is described above along with the utility estimation module 208. By updating the ‘TU’ based on the utility value of each selected foundation model, the foundation model pipeline is optimized, while considering an effect of one foundation model's performance on the other foundation model's performance. Further, the selection module 210 may remove the respective foundation model “L_(j)” from the available foundation models ‘L_A’. Then, the available foundation models ‘L_A’ may be represented as: L_A=L_A-‘L_(j)’.

After selecting the foundation model ‘L_(j)’, the selection module 210 may identify the functional requirement values/task requirements ‘TR_(j)’ satisfied by the selected foundation model ‘L_(j)’. The selection module 210 may identify the functional requirement values/task requirements ‘TR_(j)’ satisfied by the selected foundation model ‘L_(j)’ by comparing the functional values of the foundation models ‘L_(j)’ against the functional requirement values. The selection module 210 may update the functional requirement values ‘TR_A’ associated with a set of required tasks ‘T_A’, wherein the set of required tasks belong to the tasks ‘T’ identified by the task and value identification module 206 from the request. For example, the functional requirement values ‘TR_A’ may be updated as TR_A=TR_A-TR_(j). After updating the functional requirement values ‘TR_A’ associated with the set of required tasks ‘T_A’, the selection module 210 may identify the tasks ‘T_(j)’ from the set of required tasks ‘T_A’ associated with the satisfied functional requirement values ‘TR_A’. Further, the selection module 210 may update the set of required tasks ‘T_A’ by removing the tasks ‘T_(j)’ identified with the satisfied functional requirement values ‘TR_A’. For example, the set of required tasks may be updated as: T_A=T_A-T_(j).

After updating the functional requirement values and the set of required tasks, the selection module 210 updates the foundation model pipeline ‘P’ by including the selected foundation model ‘L_(j)’ in the foundation model pipeline ‘P’. For example, the foundation model pipeline may be updated as: P=P U {L_(j)}. The selection module 210 iteratively repeats the above-described steps of updating the foundation model pipeline ‘P’ till the functional requirement values associated with all the tasks are satisfied (i.e., selecting the foundation models for all the remaining tasks) that is T_A=0 or till the selection of all the foundation models from the available foundation models L_A that is L_A=0.

If |P|≤|T_A| and T_A=null, the selection module 210 may identify that the available foundation models ‘L_A’ are sufficient to satisfy all the functional requirement values and ‘P’ is the utility optimized selected set of foundation models. If T_A≠null, the selection module 210 may identify that available foundation models ‘L_A’ are not sufficient to satisfy all the functional requirement values associated with the set of required tasks.

Therefore, in accordance with implementations of the present disclosure, the foundation model pipeline may be generated by solving the following optimization problem:

$$Maximize {\sum }_{i = 1}^{L} ( S\_ ( i ) \times U\_ ( i ) ) ) , while {\sum }_{i = 1}^{L} S\_ ( i ) \leq \vert T\_A \vert$$

wherein, ‘S_(i)’ may indicate whether the foundation models are selected for the tasks or not. For example, S_(i)= ‘1’ if one or more foundation models are selected for the tasks and S_(i)= ‘0’ if any of the foundation models is not selected for the tasks.

FIG. 3 depicts an example process flow of generating the foundation model pipeline for the tasks in accordance with implementations of the present disclosure. The model selector 130 of the model management system 112 (as described in FIGS. 1 and 2) generates the foundation model pipeline for the tasks. The foundation model pipeline is a composition of the set of foundation models selected for the tasks.

The model selector 130 obtains the information 302 about the foundation models available to perform the one or more tasks and the functional values of the foundation models with respect to each task (i.e., foundation model information). In an example, the available foundation models include a foundation model A, a foundation model B, a foundation model C, and a foundation model D, as depicted in table 1. Each of the foundation models A, B, C, and D perform the tasks such as conversation, financial question and answering (Q&A), conversation summarization, and marketing Q&A. The functional values of the foundation models with respect to each task include accuracy, latency, and size, as depicted in table 1. The size of the foundation model may correspond to a number of parameters of the respective foundation model. It should be noted that the functional values of the foundation models depicted in table 1 may derived from execution of the foundation models on a specific hardware instance and may vary based on the hardware instances used for execution of the foundation models.

TABLE 1
Foundation models and associated functional values.

| | | | Task | | Task | | Task- | | |
|---|---|---|---|---|---|---|---|---|---|
| | Task | | Financial | | Conversation | | Marketing | | |
| | Conversation | | Q&A | | Summarization | | Q&A | | Size |
| Foundation | A | L | A | L | A | L | A | L | (Billion |
| model name | (%) | (sec) | (%) | (sec) | (%) | (sec) | (%) | (sec) | Parameter) |
| Model-A | 82 | 2 | 70 | 10 | 75 | 10 | 60 | 5 | 15 |
| Model-B | 82 | 3 | 70 | 11 | 70 | 12 | 70 | 4 | 16 |
| Model-C | 80 | 5 | 85 | 14 | 75 | 10 | 86 | 8 | 30 |
| Model-D | 85 | 100 | 85 | 50 | 90 | 75 | 90 | 125 | 250 |

The model selector 130 obtains the tasks to be performed and the contextual parameters 304. The contextual parameters include the functional requirement values and the user preference values associated with the tasks. In an example, the tasks to be performed includes financial Q&A, conversation, and conversation summary, as depicted in table 2. Also, as depicted in table 2, the functional requirement values indicate accuracy, latency, size and/or the like to be satisfied while performing the tasks.

TABLE 2
Tasks to be performed and associated
functional requirement values.

| | | Required | |
|---|---|---|---|
| | Required | Latency | Size |
| | Accuracy | Seconds | (Billion |
| Task-Name | (%) | (sec) | Parameter) |
| Financial Q&A | 85 | 10 | 15 |
| Conversation | 80 | 3 | 15 |
| Conversation | 70 | 10 | 15 |
| Summarization | | | |

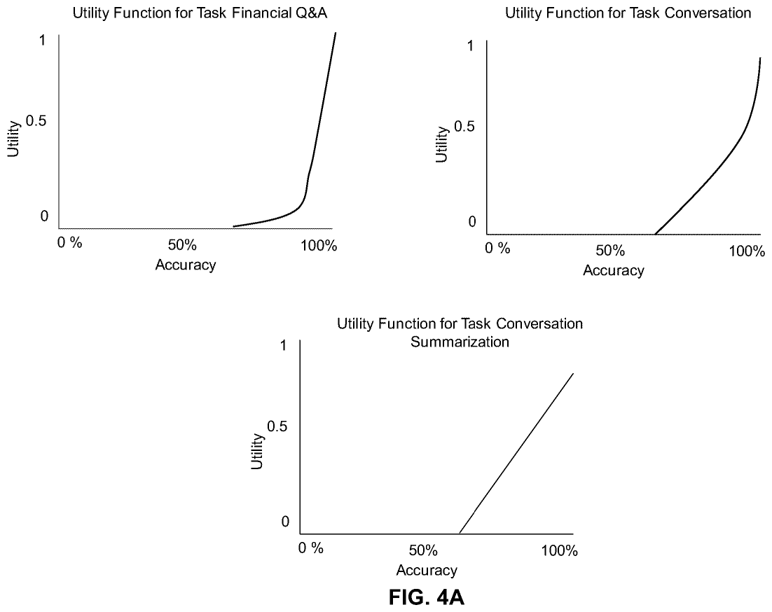

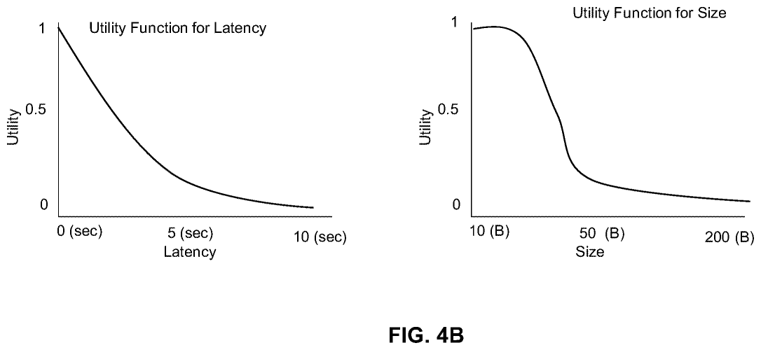

Upon obtaining the functional requirement values and the user preference values, the model selector 130 derives the utility functions 306 pre-defined by the users according to the user preference values and maps the derived utility functions with the functional requirement values and the user preference values associated with the tasks. The utility functions represent different contextual specifications for the tasks. Exemplary utility functions are depicted in FIGS. 4A and 4B, and tables 3 and 4.

The utility functions derived for the tasks (such as financial Q&A, conversation, and conversation summarization) with respect to one of the functional requirement values (i.e., accuracy) are depicted in FIG. 4A. Similarly, the utility functions that are common to all the tasks and corresponding to the functional requirement values such as latency and size are depicted in FIG. 4B.

Further, the utility functions with respect to the accuracy (i.e., the functional requirement value) for the tasks such as conversation and financial Q&A are depicted in table 3. The utility functions with respect to the latency and the size (i.e., the functional requirement values) for all the tasks, are depicted in table 4.

TABLE 3
User preferred utility functions with respect to accuracy

| | Task-Conversation | Task- Finance Q&A |
|---|---|---|
| Utility | U_C = 0 if accuracy ≤ | U_F = 0 if accuracy ≤ |
| functions | 75% | 65% |
| (Accuracy) | U_C = accuracy/100-0.7 | U_F = accuracy/100 |
| | if 75% ≤ accuracy ≤ 90% | if 65% ≤ accuracy ≤ 90% |
| | U_C = 1 otherwise | U_F = 1 otherwise |

TABLE 4
User preferred utility functions with respect to latency and size

| | Latency | Size/Run time |
|---|---|---|
| Utility | U_L = 1 if latency < 2 sec | U_S = 0 if size ≤ 5 billion |
| functions | U_L = 1/latency-0.4 | U_S = 1/size if 5 billion < size |
| | if 2 sec ≤ latency < 10 sec | |
| | U_L = 0.1 otherwise | |

Upon obtaining the functional requirement values and the user preference values, the model selector 130 estimates the utility values 308 for each of the foundation models with respect to each of the tasks. The utility values of the foundation model may be estimated based on the utility functions and the functional values of the foundation model. In an example, the utility values of the foundation model A estimated with respect to the functional requirement values (accuracy, latency, and size) and the individual total utility of the foundation model A for the task like conversation is depicted in table 5. The individual total utility of the foundation model A may be a summation of the utility values estimated with respect to all the functional requirement values.

TABLE 5
Utility values and individual total utility
of foundation model A for conversation

| | | |
|---|---|---|
| Task | | Individual |
| Conversation | Size | Total Utility |

| | A | L | (Billion | U_C + U_L + |
|---|---|---|---|---|
| | (%) | (sec) | Parameter) | U_S |
| Model A | 82 | 2 | 15 | 2.65 |
| Utility value | 0.75 | 0.9 | 1 | |

In an example, the utility values of the foundation model A estimated with respect to the functional requirement values (accuracy, latency, and size) and the individual total utility of the foundation model A for the tasks such as conversation and financial Q&A are depicted in table 6.

TABLE 6
Utility values and individual total utility of foundation
model A for conversation and financial Q&A

| | | | Task | | | |
|---|---|---|---|---|---|---|
| | Task | | Financial | | | Individual |
| | Conversation | | Q&A | | Size | Total Utility |
| | A | L | A | L | (Billion | (U_C + U_L) + (U_F + |
| | (%) | (sec) | (%) | (sec) | Parameter) | U_L) + U_S |
| Model A | 82 | 2 | 70 | 10 | 15 | 3.45 |
| Utility value | 0.75 | 0.9 | 0.7 | 0.1 | 1 | |

After estimating the utility values of each foundation model, for each of the tasks, the model selector 130 selects the foundation model 310 from the foundation models and updates the total utility ‘TU’ 312 of all the foundation models based on the utility values of the selected foundation model. Thereafter, the model selector 130 updates the utility values of the other foundation models with respect to the functional requirement values 314. The model selector 130 repeats the above-described steps (310, 312, and 314) till the estimation of the total utility by selecting all the foundation models.

For example, for the task conversation, the model selector 130 selects the foundation model A and updates the total utility ‘TU’ of all the foundation models A, B, C, and D. For example, the total utility ‘TU’ may be updated as: TU=TU+individual total utility of foundation model A=2.65 (i.e., a sum of the utility values of the model A with respect to accuracy, latency, and size), wherein initially TU=0. After updating the ‘TU’ using the utility values of the foundation model A, the model selector 130 updates the utility values of each of the foundation models B, C, and D with respect to all the functional requirement values. Further, the model selector 130 selects the foundation model B and updates the total utility ‘TU’ of all the foundation models A, B, C and D. The total utility ‘TU’ may be updated as TU=2.65+individual total utility value of model B (1)=3.65.

After updating the ‘TU’ using the utility values of the foundation model B, the model selector 130 updates the utility values of each of the foundation models C and D with respect to all the functional requirement values. Further, the model selector 130 selects the model C and updates the total utility ‘TU’ of all the foundation models A, B, C and D. The total utility ‘TU’ may be updated as TU=3.65+individual total utility of model C (0.6)=4.25.

Once the ‘TU’ using the utility values of the model C is updated, the model selector 130 updates the utility values of the foundation model D with respect to all the functional requirement values. Further, the model selector 130 selects the foundation model D and updates the total utility ‘TU’ of all the foundation models A, B, C and D. The total utility ‘TU’ may be updated as TU=4.25+individual total utility of model D (0.5)=4.75. Therefore, the total utility of the foundation models A, B, C and D for the task conversation is 4.25. Similarly, the model selector 130 may select the total utility of the foundation models A, B, C and D with respect to the other tasks by repeating the above steps. For example, the utility values and individual total utility of each of the foundation models A, B, C, and D with respect to the functional requirement values associated with the task conversation and the total utility of all the foundation models A, B, C, and D with respect to the task conversation is depicted in table 7.

TABLE 7
Utility values, individual total utility, and total/overall
utility of foundation models for task conversation

| | Model A | | Model B | | Model C | | Model D | | |
|---|---|---|---|---|---|---|---|---|---|
| Task: | Functional | Utility | Functional | Utility | Functional | Utility | Functional | Utility | |
| Conversation | value | value | value | value | value | value | value | value | TU |
| Accuracy | 82 | 0.75 | 82 | 0 | 80 | 0 | 80 | 0 | |
| (%) | | | | | | | | | |
| Latency | 2 | 0.9 | 3 | 0 | 5 | 0 | 5 | 0 | |
| (seconds) | | | | | | | | | |
| Size (B) | 15 | 1 | 16 | 1 | 30 | 0.6 | 20 | 0.5 | |
| Individual | | 2.65 | | 1.0 | | 0.6 | | 0.5 | 4.75 |
| Total Utility | | | | | | | | | |

After estimating the utility values of each of the foundation models and the total utility of all the foundation models, the model selector 130 selects the foundation model with the highest/maximum utility 316 among the foundation models. Further model selector 130 updates the functional requirement values and the tasks 318 based on the selection of the foundation model. The model selector 130 may update the functional requirement values and the tasks by identifying the functional requirement values satisfied by the selected foundation model and the tasks associated with the satisfied functional requirement values. After updating the functional requirement values, the model selector 130 updates the utility values of the other foundation models 320, based on the remaining tasks and the associated functional requirement values. Further, the model selector 130 adds the selected foundation model to the foundation model pipeline 322. Thereafter, the model selector 130 repeats the above-described steps (316-322), till the functional requirement values associated with all the tasks are satisfied or all the foundation models are selected.

For example, the model selector 130 selects the foundation model A, as the foundation model A have the highest/maximum utility values among the other foundation models B, C, and D. Upon selection of the foundation model A, the model selector 130 identifies that the foundation model A satisfies the functional requirement values associated with the tasks such as conversation and conversation summarization, based on the functional values of the foundation model A. Accordingly, the model selector 130 updates the functional requirement values and the associated tasks, and the utility values of the other foundation models B, C, and D, as depicted in table 7.

TABLE 7
Updated utility values

| | | | Task | | Task | | Task- | | | |
|---|---|---|---|---|---|---|---|---|---|---|
| | Task | | Financial | | Conversation | | Marketing | | | |
| Foundation | Conversation | | Q&A | | Summarization | | Q&A | | Size | Total |
| model name | U_A | U_L | U_A | U_L | U_A | U_L | U_A | U_L | U_S | utility |
| Model-A | 0.75 | 0.9 | 0.7 | 0.95 | 0.8 | 0.95 | 0 | 0 | 0.9 | 5.95 |
| Model-B | 0 | 0 | 0.7 | 0.8 | 0 | 0 | 0 | 0 | 0.9 | 2.4 |
| Model-C | 0 | 0 | 0.8 | 0.95 | 0 | 0 | 0 | 0 | 0.7 | 2.45 |
| Model-D | 0 | 0 | 0.85 | 0.2 | 0 | 0 | 0 | 0 | 0.3 | 1.35 |

After selecting the foundation model A, the model selector 130 selects the model C, which is having the highest/maximum utility values among the remaining foundation models B and D. The model selector 130 identifies that the foundation model C satisfies the functional requirement values associated with the tasks like finance Q&A. As the foundation models A and C satisfies the functional requirement values of all tasks such as conversation, conversation summarization, and financial Q&A, the model selector 130 generates a foundation pipeline for the respective tasks. The generated foundation pipeline includes the foundation model A and the foundation model C, which is optimized by the total utility of all the foundation models A, B, C, and D. The foundation model A may be used for the tasks such as conversation and conversation summarization. The foundation model C may be used for the task like financial Q&A.

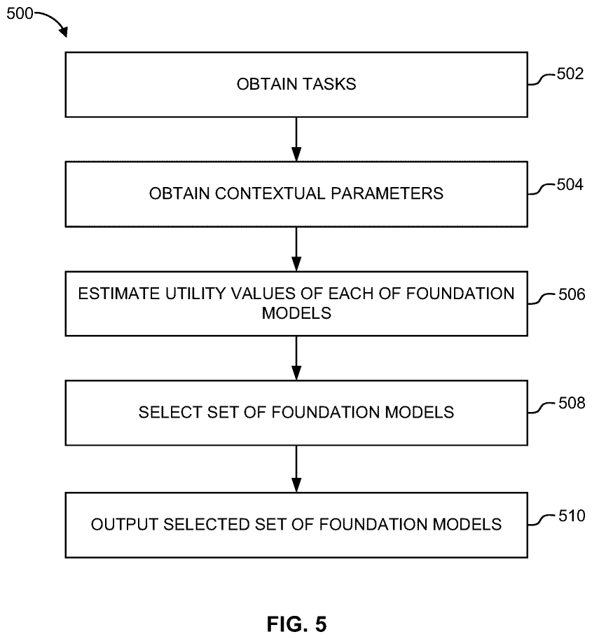

FIG. 5 is a flow diagram that presents an example method 500 for selecting foundation models for tasks in accordance with implementations of the present disclosure. In some implementations, the method 500 may be executed within the model selector 130 as described in relation to FIGS. 2 and 3.

At step 502, the method includes obtaining the tasks. The tasks may be performed using the foundation models 116a-116n. Examples of the tasks may include conversation (Q&A), conversation summarization, code generation, process planning, process execution, and/or the like.

At step 504, the method includes obtaining contextual parameters. The contextual parameters include functional requirement values describing operating characteristics of the foundation models 116a-116n required for the tasks. The contextual parameters further include user preference values. The user preference values indicate execution rules for executing the foundation models 116a-116n in order to perform the tasks.

At step 506, the method includes estimating the utility values of each of the foundation models 116a-116n with respect to the functional requirement values. The utility values may be estimated using the functional requirement values and the user preference values.

For estimating the utility values of the foundation model, the user preference values may be mapped with the functional requirement values required for the tasks. The mapped user preference values and the functional requirement values may provide the utility functions with respect to the functional requirement values and the tasks. Based on the utility functions, the utility values of the foundation model may be estimated with respect to the functional requirement values. For a task, a utility value of the foundation model with respect to a functional requirement value may be estimated by comparing the functional value of the foundation model with a utility function associated with the respective functional requirement value and the respective task (as described detail in conjunction with FIG. 3).

At step 508, the method includes selecting a set of foundation models. The set of foundation models may be selected from the foundation models 116a-116n for the tasks, based on the estimated utility values of each foundation model. The functional requirement values and the user preference values constrain the selection of the set of foundation models. The set of foundation models are selected to maximize the utility values, minimize a total number of foundation models required for the tasks and satisfy the functional requirement values.

At step 510, the method includes outputting the selected set of foundation models. The selected set of foundation models may be used for performing the tasks. The selected set of foundation models provides user-specific and application-specific required task quality while maximizing cost efficiency and sustainability. Therefore, performance of the multi-GAI paradigm is enhanced with the selection of set of foundation models from user-perspective, cost-perspective, and sustainability perspective.

Implementations of the present disclosure provides technical solutions to multiple technical problems that arise in the context of applications interacting with multiple foundation models (in a multi-model GAI paradigm). For example, implementations of the present disclosure optimize use of technical resources (processors, memory, bandwidth) with respect to context-specific objectives (application tasks) to achieve, for example, cost reduction (e.g., in terms of technical resources expended) and/or improvements in UX (e.g., reduced latency).

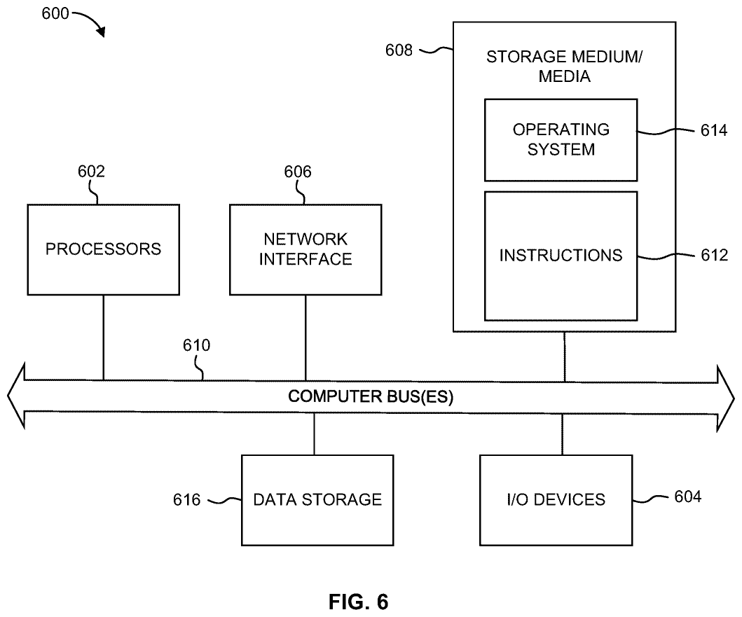

FIG. 6 illustrates a computer system 600 that may be used to implement the computer-implemented method 500 being performed by the model management system 112. More particularly, computing machines such as desktops, laptops, smartphones, tablets, and wearables which may be used to select the foundation models 116a-116n for the tasks that may have the structure of the computer system 600. The computer system 600 may include additional components not shown and that some of the process components described may be removed and/or modified. In another example, a computer system 600 may be deployed on external-cloud platforms such as cloud, internal corporate cloud computing clusters, organizational computing resources, and/or the like.

The computer system 600 includes processor(s) 602, such as a central processing unit, ASIC or another type of processing circuit, input/output devices 604, such as a display, mouse keyboard, etc., a network interface 606, such as a Local Area Network (LAN), a wireless 802.11x LAN, a 3G or 4G mobile WAN or a WiMax WAN, and a computer-readable medium 608. Each of these components may be operatively coupled to a bus 610. The computer-readable medium 608 may be any suitable medium that participates in providing instructions to the processor(s) 602 for execution. For example, the computer-readable medium 608 may be non-transitory or non-volatile medium, such as a magnetic disk or solid-state non-volatile memory or volatile medium such as RAM. The instructions or modules stored on the computer-readable medium 608 may include machine-readable instructions 612 executed by the processor(s) 602 that cause the processor(s) 602 to perform the computer-implemented method 500 and functions of the model management system 112.

The model management system 112 may be implemented as software stored on a non-transitory processor-readable medium and executed by the processors 602. For example, the computer-readable medium 608 may store an operating system 614, such as MAC OS, MS WINDOWS, UNIX, or LINUX, and code for the model management system 112. The operating system 614 may be multi-user, multiprocessing, multitasking, multithreading, real-time, and the like. For example, during runtime, the operating system 614 is running and the code for the model management system 112 is executed by the processor(s) 602.

The computer system 600 may include a data storage 616, which may include non-volatile data storage. The data storage 616 stores any data used or generated by the model management system 112.

The network interface 606 connects the computer system 600 to internal systems for example, via a LAN. Also, the network interface 606 may connect the computer system 600 to the Internet. For example, the computer system 600 may connect to web browsers and other external applications and systems via the network interface 606.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for selecting foundation models, comprising:
obtaining, by one or more processors, a set of tasks;
obtaining, by the one or more processors, a plurality of contextual parameters, wherein the plurality of contextual parameters includes a set of functional requirement values and user preference values, wherein the set of functional requirement values describe operating characteristics of a foundation model of a plurality of foundation models;
estimating, by the one or more processors, utility values of the foundation model, of the plurality of foundation models, wherein the estimated utility values are based on the set of functional requirement values and user preference values;
selecting, by the one or more processors, a set of foundation models, from the plurality of foundation models, based on the estimated utility values, wherein the set of functional requirement values and user preference values constrain the selection of the set of foundation models; and
outputting, by the one or more processors, the set of foundation models for performing the set of tasks.

2. The method of claim 1, wherein selecting the set of foundation models comprises:
selecting, from a set of available foundation models of the plurality of foundation models, a foundation model having a highest utility among other foundation models of the set of available foundation models;
comparing functional values of the selected foundation model against functional requirement values associated with a task of the set of tasks to identify a functional requirement value of the set of functional requirement values and a task of the set of tasks satisfied by the selected foundation model;
updating the set of tasks and the estimated utility values of the other foundation models based on the functional requirement value satisfied and the task; and
remove the selected foundation model from the set of available foundation models to update the set of available foundation models.

3. The method of claim 2, further comprising:
repeating steps of:
selecting the foundation model having the highest utility among other foundation models of the set of available foundation models;
comparing the functional values of the selected foundation model against the set of functional requirement values associated with the set of tasks to identify the functional requirement value and the task of the set of tasks satisfied by the selected foundation model;
updating the set of tasks and the estimated utility values of the other foundation models based on the functional requirement value satisfied and the task; and
updating the set of available foundation models by removing the selected foundation model from the set of available foundation models;
until all of the set of functional requirement values of the set of tasks are satisfied or all the available foundation models are selected.

4. The method of claim 1, further comprising estimating a total utility of the plurality of foundation models based on the estimated utility values of the foundation models.

5. The method of claim 4, wherein the total utility of the plurality of foundation models is estimated using a total utility estimation technique.

6. The method of claim 1, wherein the foundation models comprise large language models.

7. The method of claim 1, wherein the set of functional requirement values comprises at least one of an accuracy of a foundation model for one or more tasks, latency, and a runtime of the foundation model.

8. An apparatus for selecting foundation models, the apparatus comprising:
at least one memory; and
at least one processor coupled to the at least one memory, the at least one processor being configured to:
obtain a set of tasks;
obtain a plurality of contextual parameters, wherein the plurality of contextual parameters includes a set of functional requirement values and user preference values, wherein the set of functional requirement values describe operating characteristics of a foundation model of a plurality of foundation models;
estimate utility values of the foundation model, of the plurality of foundation models, wherein the estimated utility values are based on the set of functional requirement values and user preference values;
select a set of foundation models, from the plurality of foundation models, based on the estimated utility values, wherein the set of functional requirement values and user preference values constrain the selection of the set of foundation models; and
output the set of foundation models for performing the set of tasks.

9. The apparatus of claim 8, wherein, to select the set of foundation models, the at least one processor is configured to:
select, from a set of available foundation models of the plurality of foundation models, a foundation model having a highest utility among other foundation models of the set of available foundation models;
compare functional values of the selected foundation model against functional requirement values associated with a task of the set of tasks to identify a functional requirement value of the set of functional requirement values and a task of the set of tasks satisfied by the selected foundation model;
update the set of tasks and the estimated utility values of the other foundation models based on the functional requirement value satisfied and the task; and
remove the selected foundation model from the set of available foundation models to update the set of available foundation models.

10. The apparatus of claim 9, wherein the at least one processor is further configured to:
repeat steps of:
selecting the foundation model having the highest utility among other foundation models of the set of available foundation models;
comparing the functional values of the selected foundation model against the set of functional requirement values associated with the set of tasks to identify the functional requirement value and the task of the set of tasks satisfied by the selected foundation model;
updating the set of tasks and the estimated utility values of the other foundation models based on the functional requirement value satisfied and the task; and
updating the set of available foundation models by removing the selected foundation model from the set of available foundation models;
until all of the set of functional requirement values of the set of tasks are satisfied or all the available foundation models are selected.

11. The apparatus of claim 8, wherein the at least one processor is further configured to estimate a total utility of the plurality of foundation models based on the estimated utility values of the foundation models.

12. The apparatus of claim 11, wherein the total utility of the plurality of foundation models is estimated using a total utility estimation technique.

13. The apparatus of claim 8, wherein the foundation models comprise large language models.

14. The apparatus of claim 8, wherein the set of functional requirement values comprise at least one of an accuracy of a foundation model for one or more tasks, latency, and a runtime of the foundation model.

15. A non-transitory computer-readable medium having stored thereon instructions that, when executed by at least one processor, cause the at least one processor to:
obtain a set of tasks;
obtain a plurality of contextual parameters, wherein the plurality of contextual parameters includes a set of functional requirement values and user preference values, wherein the set of functional requirement values describe operating characteristics of a foundation model of a plurality of foundation models;
estimate utility values of the foundation model, of the plurality of foundation models, wherein the estimated utility values are based on the set of functional requirement values and user preference values;
select a set of foundation models, from the plurality of foundation models, based on the estimated utility values, wherein the set of functional requirement values and user preference values constrain the selection of the set of foundation models; and
output the set of foundation models for performing the set of tasks.

16. The non-transitory computer-readable medium of claim 15, wherein, to select the set of foundation models, the instructions cause the at least one processor to:
select, from a set of available foundation models of the plurality of foundation models, a foundation model having a highest utility among other foundation models of the set of available foundation models;
compare functional values of the selected foundation model against functional requirement values associated with a task of the set of tasks to identify a functional requirement value of the set of functional requirement values and a task of the set of tasks satisfied by the selected foundation model;
update the set of tasks and the estimated utility values of the other foundation models based on the functional requirement value satisfied and the task; and
remove the selected foundation model from the set of available foundation models to update the set of available foundation models.

17. The non-transitory computer-readable medium of claim 16, wherein the instructions cause the at least one processor to:
repeat steps of:
selecting the foundation model having the highest utility among other foundation models of the set of available foundation models;
comparing the functional values of the selected foundation model against the set of functional requirement values associated with the set of tasks to identify the functional requirement value and the task of the set of tasks satisfied by the selected foundation model;
updating the set of tasks and the estimated utility values of the other foundation models based on the functional requirement value satisfied and the task; and
updating the set of available foundation models by removing the selected foundation model from the set of available foundation models;
until all of the set of functional requirement values of the set of tasks are satisfied or all the available foundation models are selected.

18. The non-transitory computer-readable medium of claim 15, wherein the instructions cause the at least one processor to estimate a total utility of the plurality of foundation models based on the estimated utility values of the foundation models.

19. The non-transitory computer-readable medium of claim 18, wherein the total utility of the plurality of foundation models is estimated using a total utility estimation technique.

20. The non-transitory computer-readable medium of claim 15, wherein the foundation models comprise large language models.
